(19) United States
(12) Patent Application Publication
(10) Pub. No.: US 2026/0003338 A1
(43) Pub. Date: Jan. 1, 2026

(54) NUMERICAL CONTROL DEVICE AND NUMERICAL CONTROL METHOD

(71) Applicant: Mitsubishi Electric Corporation, Tokyo (JP)

(72) Inventors: Takashi SUEDA, Tokyo (JP); Kensuke BABA, Tokyo (JP)

(73) Assignee: Mitsubishi Electric Corporation, Tokyo (JP)

(21) Appl. No.: 19/131,955

(22) PCT Filed: Jun. 16, 2023
(86) PCT No.: PCT/JP2023/022473

§ 371 Date: May 22, 2025

(51) Int. Cl. G05B 19/402

(52) U.S. Cl. CPC G05B 19/402; G05B 2219/39001; G05B 2219/50047

(57) ABSTRACT

A numerical control device controls a machine tool and the other machine tools, and a robot. The numerical control device includes: a coordinate system offset measurement processing unit that measures coordinate system offsets for the machine tool and the other machine tools using stop positions of the robot at the machine tool and the other machine tools in performing work and measurement start coordinates that indicate a position to start a measurement operation of the coordinate system offsets; a coordinate system offset table that associates, together with the stop positions and the measurement start coordinates, the measured coordinate system offsets with the machine tool and the other machine tools; and a coordinate system offset reflection processing unit that controls the robot by reflecting the coordinate system offsets in executing a machining program.

### FIELD

The present disclosure relates to a numerical control device and a numerical control method for controlling a machine tool and a robot.

### BACKGROUND

Typically, in a system for causing a machine tool and a robot to operate cooperatively, the machine tool and the robot include separate controllers, programming languages used for controlling the machine tool and the robot are different from each other, and a coordinate system of the machine tool and a coordinate system of the robot are different from each other. In a system including a machine tool and a robot, separate creation of a program for controlling the machine tool and a program for controlling the robot makes it difficult to understand a cooperation operation between the machine tool and the robot from the programs, possibly resulting in an increase in a workload at the startup of the system. Thus, a technique has been proposed for controlling both a machine tool and a robot using a programming language for the machine tool.

Patent Literature 1 discloses a numerical control device that controls a robot by transmitting a programming language for a machine tool to a robot controller. A difference between a coordinate system of the machine tool and a coordinate system of the robot is controlled in consideration of the difference obtained by measuring the relative relationship between the coordinate system of the machine tool and the coordinate system of the robot.

### CITATION LIST

### Patent Literature

Patent Literature 1: Japanese Patent No. 6647472

### SUMMARY OF INVENTION

### Problem to be Solved by the Invention

A plurality of machine tools is installed in a factory, and one robot may in some cases perform carrying-in and carrying-out work with respect to the plurality of machine tools. With the technique of Patent Literature 1, when a single machine tool controls a robot, the single machine tool needs to measure, hold, and apply a relative relationship between the coordinate system of the robot and the coordinate systems of the plurality of machine tools. Although measurement and application typically require control in accordance with, for example, a machining program, the need for considering different machining processes puts a large burden on an operator in creating the machining program.

The present disclosure has been made in view of the above circumstances, and an object of the present disclosure is to provide a numerical control device capable of reducing a burden on an operator in creating a machining program for controlling a plurality of machine tools and a robot.

### Means to Solve the Problem

In order to solve the above-described problem and achieve the object, a numerical control device according to the present disclosure controls a plurality of machine tools and a robot to perform work on the plurality of machine tools. The numerical control device includes: a measurement processing unit to measure a coordinate system offset of each of the machine tools using a stop position of the robot at each machine tool in performing the work and a measurement start position that is a position to start a measurement operation of the coordinate system offset indicating a relationship between a coordinate system of each machine tool and a coordinate system of the robot; an associating unit to associate, together with the stop position and the measurement start position, the coordinate system offset measured by the measurement processing unit with each machine tool; and a reflection processing unit to control, in executing a machining program, the robot by reflecting the coordinate system offset associated.

### EFFECTS OF THE INVENTION

The numerical control device of the present disclosure has an effect of being able to reduce the burden on the operator in creating the machining program for controlling the plurality of machine tools and the robot.

### BRIEF DESCRIPTION OF DRAWINGS

FIG. 1 is a diagram illustrating an exemplary configuration of a control system including a numerical control device according to a first embodiment.

FIG. 2 is a diagram illustrating an exemplary configuration of the numerical control device according to the first embodiment.

FIG. 3 is a diagram illustrating an exemplary measurement of coordinate system offsets using a touch probe in the numerical control device according to the first embodiment.

FIG. 4 is a diagram illustrating an example of a coordinate system offset table stored by the numerical control device according to the first embodiment.

FIG. 5 is a diagram illustrating an example of a machining program executed by the numerical control device according to the first embodiment.

FIG. 6 is a diagram illustrating an example of a tool replacement method for a robot according to the first embodiment.

FIG. 7 is a flowchart illustrating an operation procedure of a coordinate system offset measurement processing unit of a numerical control device according to a first embodiment.

FIG. 8 is a flowchart illustrating an operation procedure of a coordinate system offset reflection processing unit of the numerical control device according to the first embodiment.

FIG. 9 is a diagram illustrating an exemplary configuration of a control system including a numerical control device according to a second embodiment.

FIG. 10 is a diagram illustrating an exemplary configuration of the numerical control device according to the second embodiment.

FIG. 11 is a diagram illustrating an example of a machining program executed by the numerical control device according to the second embodiment.

FIG. 12 is a flowchart illustrating an operation procedure of a coordinate system offset reflection processing unit of the numerical control device according to the second embodiment.

FIG. 13 is a block diagram illustrating an exemplary configuration of a control computation unit of each of the numerical control devices according to the first and second embodiments.

### DESCRIPTION OF EMBODIMENTS

Hereinafter, a numerical control device and a numerical control method according to embodiments will be described in detail with reference to the drawings.

### First Embodiment

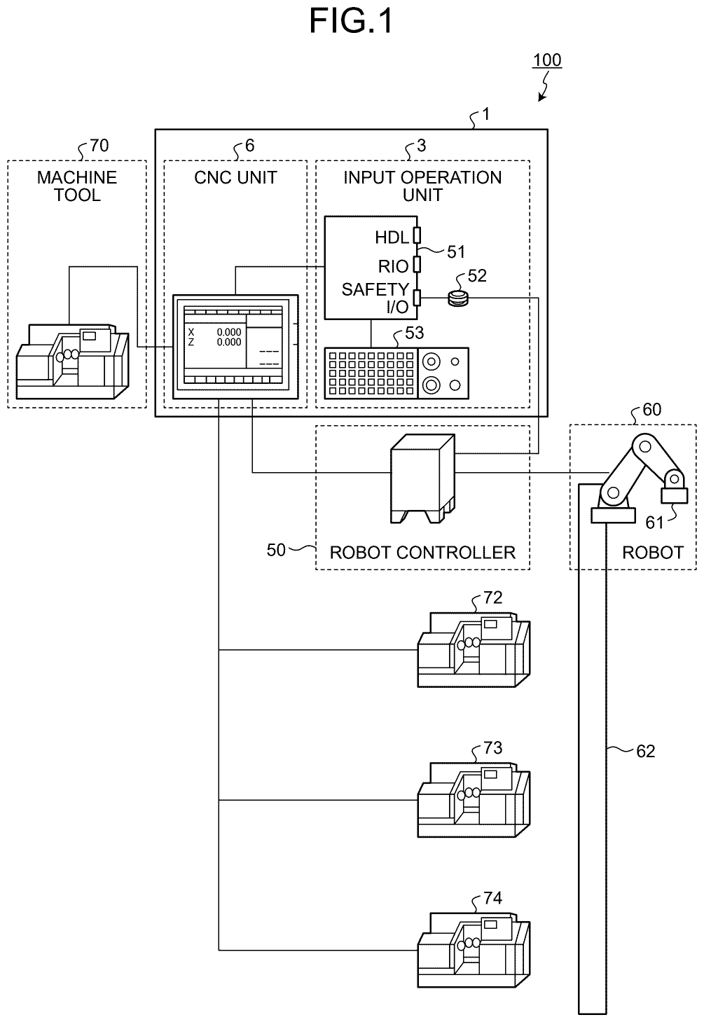

FIG. 1 is a diagram illustrating an exemplary configuration of a control system 100 including a numerical control device 1 according to a first embodiment. The numerical control device 1 according to the first embodiment creates a machining program for controlling a machine tool 70, a robot 60, and a traveling axis 62, and controls the other machine tools 72, 73, and 74. In the first embodiment, a description will be given of an example in which the numerical control device 1, which controls the machine tool 70, the robot 60, and the traveling axis 62, has a function of measuring and applying a coordinate system.

The control system 100 is a system for controlling the machine tool 70, the robot 60, and the traveling axis 62 using a Numerical Control (NC) program, which is the machining program. The control system 100 25 includes the machine tool 70, the numerical control device 1, a robot controller 50, the robot 60, the traveling axis 62, and the other machine tools 72 to 74. The numerical control device 1 includes a Computer Numerical Control (CNC) unit 6 and an input operation unit 3. In the first 30 embodiment, a form of the machine tool 70 mainly intended for metal machining will be described, but the form of the machine tool 70 is not limited thereto.

The CNC unit 6 is connected with the machine tool 70, the input operation unit 3, and the robot controller 50. The robot controller 50 is connected with the robot 60. The CNC unit 6 and the robot controller 50 are connected with each other via a network such as a Local Area Network (LAN).

The input operation unit 3 includes an input and output unit 51, an emergency stop button 52, and a control panel 53. The control panel 53 receives an operation of an operator and transmits a signal corresponding to the operation to the input and output unit 51. The emergency stop button 52, in response to being pressed by the operator, sends a signal for stopping the robot controller 50 to the robot controller 50, and at the same time, sends a signal for stopping the machine tool 70 to the input and output unit 51. The input and output unit 51 sends, to the CNC unit 6, the signal sent from the control panel 53 and the signal sent from the emergency stop button 52. The robot controller 50, in response to receiving the signal from the emergency stop button 52, emergently stops the robot 60. The CNC unit 6, in response to receiving the signal for stopping the machine tool 70 from the input and output unit 51, emergently stops the machine tool 70.

In the control system 100, communication is performed among the machine tool 70, the numerical control device 1, and the robot controller 50, and communication is performed among the robot controller 50, the robot 60, and the traveling axis 62. As described above, in the control system 100, the numerical control device 1 is connected to the robot 60 and the traveling axis 62 via the robot controller 50. The numerical control device 1 controls the robot 60 and the traveling axis 62 via the robot controller 50. Hereinafter, the description of “via the robot controller 50” may in some cases be omitted from the description of the control of the robot 60 performed by the numerical control device 1.

The CNC unit 6 is also connected with the other machine tools 72 to 74. The CNC unit 6 and the other machine tools 72 to 74 are connected with each other by an industrial network including, for example, a LAN.

In the control system 100, communication is performed between the numerical control device 1 and the other machine tools 72 to 74, and the numerical control device 1 controls the other machine tools 72 to 74. The numerical control device 1 may perform activation control of the other machine tools 72 to 74, for example, start of machining.

The numerical control device 1 is disposed in the machine tool 70. The numerical control device 1 is a computer and causes the machine tool 70 to machine a workpiece using a tool, and at the same time, causes the robot 60 to transport a workpiece. Additionally, the numerical control device 1 performs transportation of the robot 60 using the traveling axis 62 and performs activation control of the other machine tools 72 to 74, for example, start of machining.

The NC program includes a first command, which is described in a first programming language and is a command for the machine tool 70, and a second command, which is described in the first programming language and is a command for the robot 60 and the traveling axis 62. The numerical control device 1 converts the second command of the NC program into a third command, which is a command of a robot program described in a second programming language, and controls the robot 60 and the traveling axis 62 using the third command.

The input operation unit 3 is means for inputting information to a control computation unit 2 of the CNC unit 6. The control computation unit 2 will be described later. The input operation unit 3 includes input means such as a keyboard, a touch panel, a button, or a mouse. FIG. illustrates, as examples of the input means, a keyboard and a touch panel. The touch panel is, for example, a liquid crystal touch panel.

The numerical control device 1 sends the robot program including the third command to the robot controller 50. The robot controller 50 controls the robot 60 and the traveling axis 62 in accordance with the robot program sent from the numerical control device 1.

The robot 60 grips a workpiece using a robot hand 61 and transports the gripped workpiece. The robot 60 loads the unmachined workpiece into the machine tool 70 and unloads the machined workpiece from the machine tool 70. Note that the robot 60 may perform processes other than the transportation of the workpiece.

The traveling axis 62 moves the robot 60. Moving the robot 60 to a position in front of each of the other machine tools 72 to 74 by the traveling axis 62 allows the robot 60 to perform transportation, loading, and unloading of the workpiece with respect to the other machine tools 72 to 74.

The CNC unit 6 includes the control computation unit 2 to be described later and a display unit 4 to be described later. The CNC unit 6 controls the machine tool 70, the robot 60, and the traveling axis 62 using the NC program. Additionally, the CNC unit 6, in response to receiving the signal from the input operation unit 3, causes the machine tool 70 to perform a process corresponding to the received signal. Furthermore, the CNC unit 6 displays, on the display unit 4, information indicating the state of the machine tool 70, information indicating the state of the robot 60, information indicating the state of the traveling axis 62, and the like.

The machine tool 70 and the other machine tools 72 to 74 are each an NC machine tool. The NC machine tool machines a workpiece using a tool while moving the tool and the workpiece relative to each other by two or more drive axes. A first coordinate system, which is a coordinate system of the NC machine tool, and a second coordinate system, which is a coordinate system of the robot 60 different from each other. The machine tool 70, the other machine tools 72 to 74, and the robot 60 are controlled in a cartesian coordinate system to move the tool, the workpiece, or the robot hand 61 in, for example, three axial directions. The robot 60 includes rotation axes and can operate the robot hand 61 in a linear direction by rotating joints that are a plurality of axes of rotation in response to cartesian coordinate system commands.

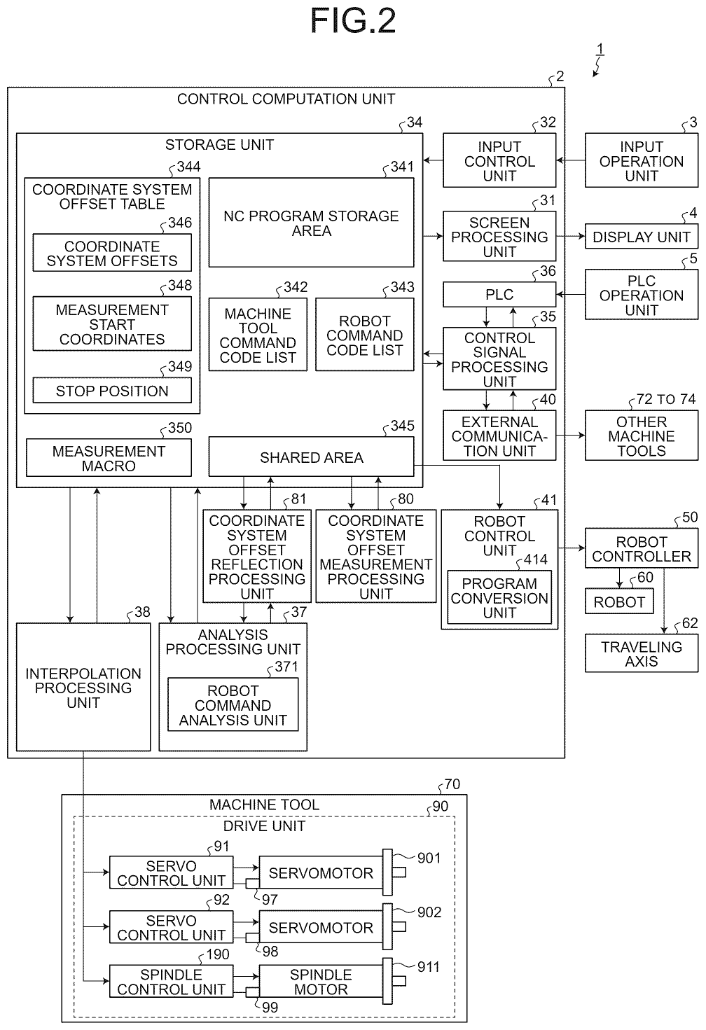

FIG. 2 is a diagram illustrating an exemplary configuration of the numerical control device 1 according to the first embodiment. The numerical control device 1 includes the control computation unit 2, the input operation unit 3, the display unit 4, and a Programmable Logic Controller (PLC) operation unit 5, such as a machine control panel, for operating a PLC 36. FIG. 2 illustrates, along with the numerical control device 1, the machine tool 70, the robot controller 50, the robot 60, the traveling axis 62, and the other machine tools 72 to 74.

The machine tool 70 and the other machine tools 72 to 74 each include a drive unit 90 that drives a tool and a workpiece. An example of the drive unit 90 is a driving mechanism for driving a tool while rotating a workpiece. In the first embodiment, the tool is driven in two directions, which are, for example, a direction parallel to an X-axis direction and a direction parallel to a Z-axis direction. Note that the axial directions depend on the device configuration and are thus not limited to the aforementioned directions.

The drive unit 90 includes servomotors 901 and 902 for moving the tool in respective axial directions defined in the numerical control device 1, and detectors 97 and 98 for detecting respective positions and speeds of the servomotors 901 and 902. The detector 97 outputs a signal indicating a result of detecting the position and the speed of the servomotor 901. The detector 98 outputs a signal indicating a result of detecting the position and the speed of the servomotor 902. The drive unit 90 includes servo control units 91 and 92 for respective axial directions for controlling the servomotors 901 and 902 based on commands from the numerical control device 1. The servo control units 91 and 92 respectively perform feedback control on the servomotors 901 and 902 based on the signals from the detectors 97 and 98.

The servo control unit 91 controls the servomotor 901 to thereby control the operation of the tool in the X-axis direction. The servo control unit 92 controls the servomotor 902 to thereby control the operation of the tool in the Z-axis direction.

The drive unit 90 also includes a spindle motor 911 for rotating a spindle for rotating a workpiece, and a detector 99 for detecting a position and a rotation speed of the spindle motor 911. The rotation speed corresponds to the number of rotations per unit time. The rotation speed detected by the detector 99 corresponds to the rotation speed of the spindle motor 911. A spindle control unit 190 controls the spindle motor 911 to thereby control the rotation of the spindle.

As described above, the input operation unit 3 includes the input means for inputting information to the control computation unit 2. The input operation unit 3 receives a command or the like for the numerical control device 1 from an operator. The input operation unit 3 also receives an NC program, a parameter, or the like. The display unit 4 is configured by display means such as a liquid crystal display device, and displays, on its screen, information processed by the control computation unit 2. An example of the display unit 4 is a liquid crystal touch panel. In this case, some functions of the input operation unit 3 are disposed on the display unit 4.

The control computation unit 2, which serves as a control unit, controls the machine tool 70, the robot 60, and the traveling axis 62 using the NC program defined in the coordinate system of the machine tool 70. The control computation unit 2 includes a screen processing unit 31, an input control unit 32, a storage unit 34, a control signal processing unit 35, the PLC 36, an analysis processing unit 37, an interpolation processing unit 38, a coordinate system offset measurement processing unit 80, which corresponds to a measurement processing unit, a coordinate system offset reflection processing unit 81, which corresponds to a reflection processing unit, an external communication unit 40, and a robot control unit 41. Note that the PLC 36 may be disposed outside the control computation unit 2.

The storage unit 34 is a device for storing data, such as a non-volatile memory or a hard disk. The storage unit 34 stores an NC program storage area 341 in which the NC program is stored, a machine tool command code list 342, and a robot command code list 343. The storage unit 34 includes a coordinate system offset table 344, a measurement macro 350, and a shared area 345, all of which will be described later.

The NC program storage area 341 stores a program for the machine tool 70 to perform machining and a program for controlling the robot 60 and the traveling axis 62.

The machine tool command code list 342 is a list of codes used for the command for the machine tool 70. The robot command code list 343 is a list of codes used for the command for the robot 60.

The input control unit 32 receives information input from the input operation unit 3 and stores, for example, the machining program and the like in the NC program storage area 341 of the storage unit 34.

The screen processing unit 31 performs control to cause the display unit 4 to display, for example, the machining program and the like in the NC program storage area 341. Additionally, the screen processing unit 31 executes display processing used for the user interface, such as information of the axis position of the machine tool 70, setting information of the machine tool 70, or graphic display related to machining.

The control signal processing unit 35 is connected with the PLC 36. The PLC 36 outputs signal information such as a relay for operating the machine tool 70 to the control signal processing unit 35. The control signal processing unit 35 receives the signal information from the PLC 36 and writes the received signal information in the shared area 345. The interpolation processing unit 38 refers to the signal information from the PLC 36 during the machining operation. Additionally, when the analysis processing unit 37 outputs auxiliary commands to the shared area 345, the control signal processing unit 35 reads the auxiliary commands from the shared area 345 and sends the auxiliary commands to the PLC 36. The auxiliary commands are commands other than a command to operate the drive axis, which is a numerically controlled axis. An example of the auxiliary commands is M-code or T-code.

The external communication unit 40 is, for example, a communication part of an industrial network. When there are commands to activate the other machine tools 72 to 74 in the auxiliary commands, the external communication unit 40 sends the commands to the other machine tools 72 to 74 via the industrial network.

In the control computation unit 2, the control signal processing unit 35, the analysis processing unit 37, the interpolation processing unit 38, the robot control unit 41, the coordinate system offset measurement processing unit 80, and the coordinate system offset reflection processing unit 81 are connected with each other via the storage unit 34, to write and read information via the shared area 345 of the storage unit 34. Hereinafter, the description of “via the storage unit 34” may in some cases be omitted from the description of writing and reading of information into and from the control signal processing unit 35, the analysis processing unit 37, the interpolation processing unit 38, the robot control unit 41, the coordinate system offset measurement processing unit 80, and the coordinate system offset reflection processing unit 81.

The analysis processing unit 37 reads the NC program from the NC program storage area 341 and performs analysis processing on each block of the NC program, that is, each line of the NC program. When the analyzed line includes G-code for the machine tool 70, the analysis processing unit 37 sends a result of the analysis processing to the interpolation processing unit 38 via the shared area 345. Specifically, the analysis processing unit 37 generates a movement condition corresponding to the G-code and sends the movement condition to the interpolation processing unit 38. The analysis processing unit 37 also sends the spindle rotation speed specified by S-code to the interpolation processing unit 38. The spindle rotation speed corresponds to the number of rotations of the spindle per unit time.

The analysis processing unit 37 includes a robot command analysis unit 371. The robot command analysis unit 371 is means for analyzing the operations of the connected robot 60 and the connected traveling axis 62. The robot command analysis unit 371 analyzes the robot command and the traveling axis command included in the NC program and sends results of analyzing these commands to the robot control unit 41.

The robot control unit 41 transmits the command for the robot 60 and the command for the traveling axis 62 to the robot controller 50.

The robot control unit 41 includes a program conversion unit 414. Using coordinate system offsets 346 stored in the coordinate system offset table 344 of the storage unit 34, the program conversion unit 414 coordinate-converts the second command defined in the coordinate system of the machine tool 70 into the third command defined in the coordinate system of the robot 60, thereby generating the robot program used in controlling the robot 60. The coordinate system offsets 346 are coordinate values indicating the relationship between the coordinate system of the machine tool 70 and the coordinate system of the robot.

The robot 60 is used not only for carrying a workpiece or the like in or out of the machine tool 70 but also for carrying a workpiece or the like in or out of each of the other machine tools 72 to 74. Thus, the coordinate system offsets 346 are stored in the coordinate system offset table 344 of the storage unit 34 by the number of the respective machine tools.

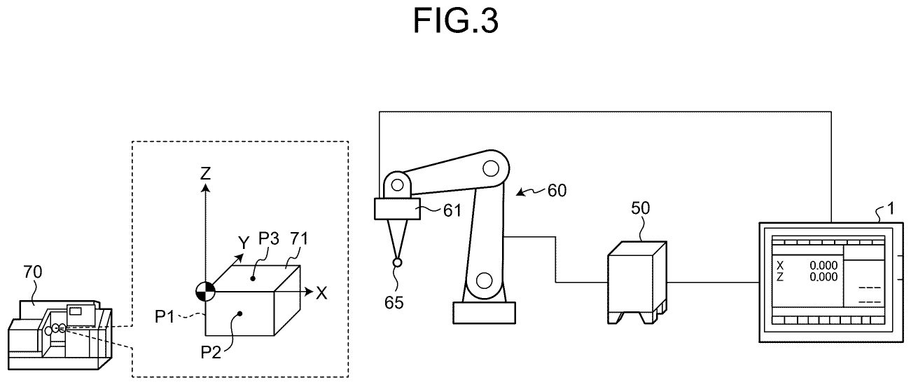

FIG. 3 is a diagram illustrating an exemplary measurement of coordinate system offsets using a touch probe in the numerical control device 1 according to the first embodiment. As illustrated in FIG. 3, the coordinate system offsets 346 are measured using a sensor, such as a touch probe 65, attached to the robot hand 61 of the robot 60. In the measurement of the coordinate system offsets 346 using the touch probe 65, the touch probe 65 is attached to the end of the robot hand 61, and a movement command for the robot hand 61 is transmitted from the numerical control device 1 to the robot controller 50, so that the touch probe 65 is pressed against a table 71 or the like of the machine tool 70. When the touch probe 65 is pressed against the table 71 or the like of the machine tool 70, a detection signal of the touch probe 65 is input to the numerical control device 1, and coordinate values in the numerical control device 1 at that time are acquired. Through measuring coordinate values P1, P2, and P3 of the three points, the coordinate origin of the table of the machine tool is calculated and the coordinate system offsets 346 are calculated. In acquiring the coordinate values, at least three points are measured and when an inclination is considered, nine points are measured.

Next, a method of measuring the coordinate system offsets 346 for a plurality of machine tools will be described. The measurement of the coordinate system offsets 346 is performed once when the factory line is started up. In the first embodiment, the coordinate system offsets 346 are measured for the machine tool 70 and the other machine tools 72 to 74.

In order to measure the plurality of coordinate system offsets 346 for the machine tool 70 and the other machine tools 72 to 74, which are a plurality of machine tools to be controlled, the control computation unit 2 of the numerical control device 1 includes the coordinate system offset measurement processing unit 80 and the measurement macro 350, and includes, in the storage unit 34, measurement start coordinates 348, which indicate a measurement start position, and a stop position 349, as the coordinate system offset table 344.

The stop position 349 is a stop position of the robot 60 on the traveling axis 62 in carrying the workpiece in or out of each of the machine tool 70 and the other machine tools 72 to 74. The number of stop positions 349 corresponding to the number of machine tools is stored in the storage unit 34. The stop positions 349 are determined based on the positions of the machine tool 70 and the other machine tools 72 to 74 with respect to the traveling axis 62. Thus, a line designer sets the stop positions when the arrangement of the machine tool 70 and the other machine tools 72 to 74 in the factory line has been determined.

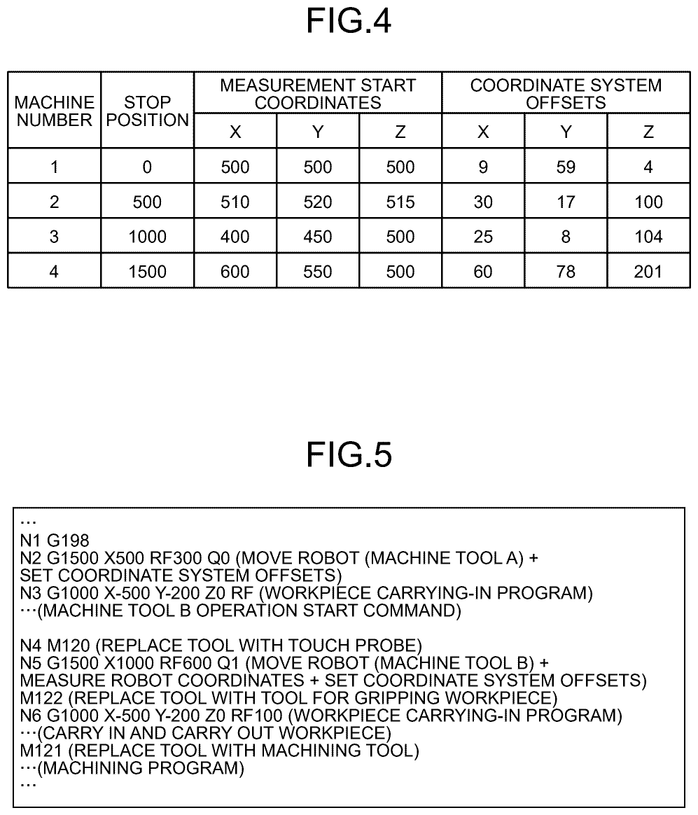

FIG. 4 is a diagram illustrating an example of the coordinate system offset table 344 stored by the numerical control device 1 according to the first embodiment. In FIG. 4, a machine number “1” corresponds to the machine tool 70, a machine number “2” corresponds to the other machine tool 72, a machine number “3” corresponds to the other machine tool 73, and a machine number “4” corresponds to the other machine tool 74. The storage contents of the coordinate system offset table 344 include the stop position 349, the measurement start coordinates 348, and the coordinate system offsets 346. The coordinate system offset table 344 stores, in association with each other, the machine number, the stop position 349, the measurement start coordinates 348, and the coordinate system offsets 346. The coordinate system offset table 344 functions as an associating unit that associates, together with the stop position 349 and the measurement start coordinates 348, the coordinate system offsets 346 with the machine tool 70 and the other machine tools 72 to 74. As the stop position 349, for example, the position of the machine tool 70 is 0, the position of the other machine tool 72 is 500, the position of the other machine tool 73 is 1000, and the position of the other machine tool 74 is 1500. The unit is determined based on settings of the numerical control device 1.

The measurement start coordinates 348 indicate a start point for starting the measurement macro 350 and need to be set such that the touch probe 65 of the robot hand 61 can start from the vicinity of the table of each machine tool. The measurement start coordinates 348 are determined based on the relationship between the position of the robot 60 and the positions of the tables of the machine tool 70 and the other machine tools 72 to 74. However, positions of the tables different depending on the machine tool 70 and the other machine tools 72 to 74 necessitate setting values for each of the machine tool 70 and the other machine tools 72 to 74. Such a method of setting values includes, for example, when the arrangement of the machine tool 70 and the other machine tools 72 to 74 in the factory line has been determined by simulation, setting values based on a result of the simulation. A conceivable alternative method includes, when the machine tool 70 and the other machine tools 72 to 74 have actually been installed, manually moving the robot 60 with, for example, a handle or the like to a position where the robot hand 61 is above the table and storing the coordinate values at this time. In the measurement start coordinates 348, as illustrated in FIG. 4, for example, in the case of the machine tool 70 corresponding to the machine number “1”, (X, Y, Z)=(500, 500, 500) and in the case of the other machine tool 72 corresponding to the machine number “2”,(X, Y, Z)=(510, 520, 515). The measurement start coordinates 348 are also stored in association with the machine number and the stop position 349.

The measurement macro 350 is a program for performing aforementioned operation of the touch probe 65 attached to the robot 60. Executing the measurement macro 350 allows the robot 60 to perform an operation of measuring the coordinate system offsets 346.

The coordinate system offset measurement processing unit 80 controls the operation of measuring the coordinate system offsets 346. The performance of the coordinate system offset measurement processing unit 80 results, for example, when an operator inputs, after replacing the tool of the robot hand 61 with the touch probe 65, a machine number corresponding to a single machine tool or “ALL” for specifying all the machine tools to the display unit 4, and then presses a measurement start button displayed on the display unit 4. When the measurement start button is pressed after an input of “1”, which is a machine number corresponding to the single machine tool, the coordinate system offsets 346 of the machine tool 70 corresponding to the machine number “1” are measured. When the measurement start button is pressed after an input of “ALL” for specifying all the machine tools, the respective coordinate system offsets 346 from the machine tool 70 corresponding to the machine number “1” to the other machine tool 74 corresponding to the machine number “4” are sequentially measured.

For example, the coordinate system offsets 346 of the machine tool 70 corresponding to the machine number “1” are measured as follows. When the measurement start button is pressed after the input of input information “1”, the screen processing unit 31 stores “1” as the input information in the shared area 345 of the storage unit 34. The analysis processing unit 37 reads, from the coordinate system offset table 344, data including the stop position 349 and the measurement start coordinates 348 of the machine number “1” corresponding to the input information “1” stored in the shared area 345, stores the data in the shared area 345, and notifies the coordinate system offset measurement processing unit 80 of the storage address of the data in the shared area 345 and a control start instruction. The coordinate system offset measurement processing unit 80, in response to receiving the control start instruction from the analysis processing unit 37, outputs, to the display unit 4, a screen display for confirming whether the replacement with the touch probe 65 has been performed, and when the completion of replacement has been confirmed, the coordinate system offset measurement processing unit 80 acquires, from the shared area 345, the stop position 349 and the measurement start coordinates 348, both of which are associated with the machine number “1”.

The coordinate system offset measurement processing unit 80 transmits, to the robot controller 50, a command for the traveling axis 62 for moving the robot 60 to a position of “0”, which is the stop position 349 of the machine tool 70 corresponding to the machine number “1”, and operates the traveling axis 62. The coordinate system offset measurement processing unit 80 transmits, to the robot controller 50, a command for moving the robot hand 61 to the measurement start coordinates 348 of the machine tool 70 corresponding to the machine number “1”, and operates the robot 60. Next, the coordinate system offset measurement processing unit 80 measures the coordinate system offset values of the machine tool 70 corresponding to the machine number “1” in accordance with the measurement macro 350. The coordinate system offset measurement processing unit 80 stores the measured coordinate system offset values of the machine tool 70 corresponding to the machine number “1” in the coordinate system offsets 346 of the machine number “1” in the coordinate system offset table 344 of the storage unit 34. During this storage, the measured coordinate system offsets 346 are stored in association with the stop position 349. The coordinate system offset values of the other machine tools 72 to 74 respectively corresponding to the machine numbers “2” to “4” are similarly measured. Then, the respective measured coordinate system offset values of the other machine tools 72 to 74 are stored in association with the respective stop positions 349 of the other machine tools 72 to 74.

Next, a description will be given of a method of, when there is a movement command for the robot 60 to move to a position in front of a specific machine tool, controlling the robot 60 in automatic consideration of the relative relationship after the robot 60 is moved by the traveling axis 62.

FIG. 5 is a diagram illustrating an example of the machining program executed by the numerical control device 1 according to the first embodiment. FIG. 5 illustrates an example of the machining program including G-code, which is a command for the machine tool 70 or the robot 60. The command of the G-code in the line of a block N2 of the machining program is a command for reflecting the movement and the offset of the robot 60.

The analysis processing unit 37 analyzes G1500 in the block N2 and determines that the G1500 denotes the robot movement and coordinate system offset reflection command of the robot command from the robot command code list 343, and the coordinate system offset reflection processing unit 81 starts the processing. The coordinate system offset reflection processing unit 81 analyzes the address following the G-code and transmits the command to the robot controller 50. The X address means the movement of the traveling axis 62, the X500 means the stop position after the movement of the traveling axis 62, the RF300 means the moving speed of the traveling axis 62, and the Q0 means not performing the measurement of the coordinate system offsets 346 after the movement. The analysis processing unit 37 analyzes the instructions and operates the traveling axis 62 to move the robot 60 to a position of “500” at a speed of “300”. When there is the command of the Q0, the coordinate system offsets 346 are not re-measured. Thus, in the command for the robot 60 in and after a block N3, the control computation unit 2 commands the robot controller 50 to operate by automatically reflecting, as the offsets of the robot 60, X30, Y17, and Z100, which are the coordinate system offsets 346 associated with the stop position “500” in the coordinate system offset table 344 illustrated in FIG. 4. Such an operation will be referred to as coordinate system offset reflection processing.

When the value of X of the X address is not present as data in the stop position 349 of the coordinate system offset table 344, the command instructs the movement to a position where the machine tool is not present, and thus the aforementioned coordinate system offset reflection processing is not performed. In this case, the coordinate system offset reflection processing unit 81 may output an error. Alternatively, the coordinate system offset reflection processing unit 81 may involve, although performing movement to the stop position of the command, not reflecting the coordinate system offsets 346.

The reflection of the coordinate system offsets 346 is a modal function, and a command in consideration of the coordinate system offsets 346 is transmitted to the robot controller 50 as a next command for the robot 60 unless there is G-code to reflect or cancel the next coordinate system offsets 346. For example, as the command for the robot 60 in the block N3, the operator is only required to create a program for specifying the movement position of the robot hand 61 in the coordinate system of the machine tool. That is, after the block N2, the operator who creates the machining program does not need to create a program in consideration of the difference between the coordinate system of the machine tool and the coordinate system of the robot.

Next, a description will be given of a method of, when there is a movement command for the robot 60 to move to the position in front of a specific machine tool, re-measuring the coordinate system offsets 346 and controlling the robot 60 in automatic consideration of the relative relationship after the robot 60 is moved by the traveling axis 62. With this method, even when physical deviation of the lane of the traveling axis 62 or the like causes a change in the coordinate system offsets 346, re-measuring the coordinate system offsets 346 before the work by the robot 60 enables highly accurate robot work on the machine tool.

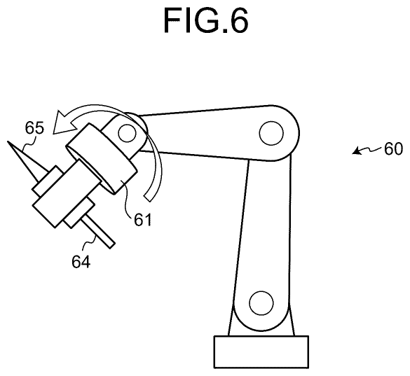

The M-code in a block N4 denotes an auxiliary command and denotes a command to replace the end of the robot hand 61 with the touch probe 65. FIG. 6 is a diagram illustrating an example of a tool replacement method for the robot 60 according to the first embodiment. For the replacement with the touch probe 65, for example, as illustrated in FIG. 6, it is conceivable that the robot hand 61 is attached, at its end, with a machining tool 64 and the touch probe 65, which is disposed on the opposite side of the machining tool 64. In such a case, for example, rotating the rotation axis of the end of the robot hand 61 by 180 degrees in accordance with the M-code auxiliary command allows the tool to be replaced with the touch probe 65.

The method for replacement with the touch probe 65 is not limited to the above. For example, a conceivable alternative method includes providing an auto-changer on a table that operates on the traveling axis physically simultaneous with the robot hand 61 and moving the robot hand 61 to the replacement position of the auto-changer for replacement.

As described above, the G1500 of a block N5 means the movement of the traveling axis 62, the X1000 means the stop position 349 after the movement of the traveling axis 62, the RF600 means the moving speed of the traveling axis 62, and the Q1 means performing the measurement of the coordinate system offsets 346 after the movement. The analysis processing unit 37 analyzes the instructions, drives the traveling axis 62, and moves the robot 60 to a position of “1000” at a speed of “600”. When there is the command of the Q1, in order to re-measure the coordinate system offsets 346, the coordinate system offset measurement processing unit 80 performs processing to re-measure the coordinate system offsets 346 in accordance with the aforementioned method of measuring the coordinate system offsets 346. The re-measured coordinate system offsets 346 are reflected in the coordinate system offset table 344. In the command for the robot 60 of the transition to a block N6, the control computation unit 2 commands to the robot controller 50 to operate by automatically reflecting, as the offsets of the robot 60, the coordinate system offsets 346, which are associated with the stop position “1000” and have been re-measured. That is, the coordinate system offset reflection processing is performed.

As described above, using the re-measured coordinate system offsets 346 enables highly accurate robot work on the machine tool.

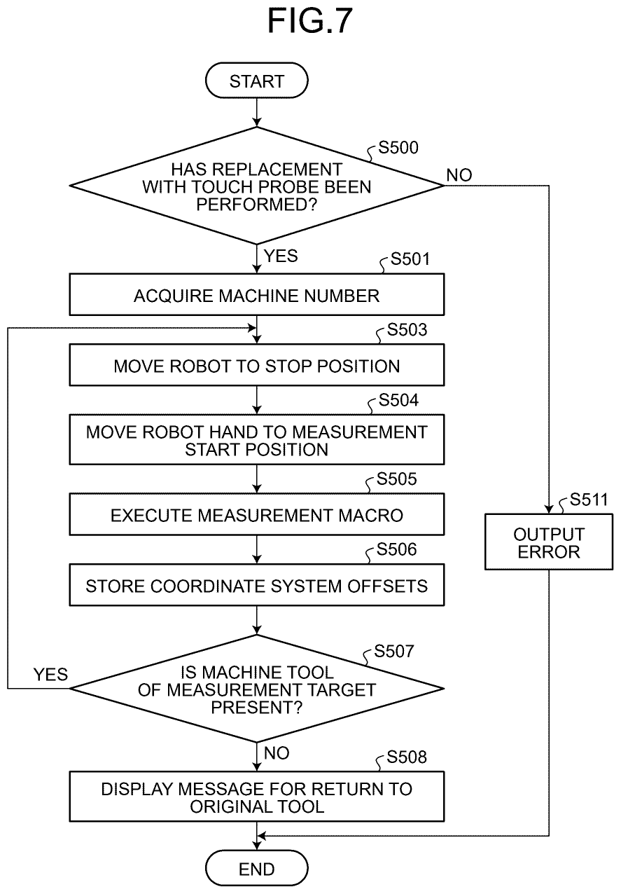

Next, a description will be given of processing of the coordinate system offset measurement processing unit 80 for achieving the aforementioned function. FIG. 7 is a flowchart illustrating an operation procedure of the coordinate system offset measurement processing unit 80 of the numerical control device 1 according to the first embodiment.

In step S500, a message for confirming with the operator whether the end of the robot hand 61 has been replaced with the touch probe 65 is displayed on the display unit 4. When the replacement has not been performed (step S500: No), an error is output (step S511), and the processing ends. When the replacement has been performed (step S500: Yes), in step S501, the machine number of the measurement target input by the operator is acquired from the shared area 345. In step S503, a movement command for the traveling axis 62 for moving the robot 60 to the stop position 349 associated with the machine number is transmitted to the robot controller 50, so that the robot 60 is moved to the stop position 349. Next, in step S504, a movement command for moving the robot hand 61 to the measurement start coordinates 348 associated with the machine number is transmitted to the robot controller 50, so that the robot hand 61 is moved to the measurement start coordinates 348.

Next, in step S505, a macro program for measuring the coordinate system offsets 346 is executed. Next, in step S506, the measured coordinate system offsets 346 are stored in the coordinate system offset table 344 in association with the machine number and the stop position 349. While the machine tool of the measurement target is present, the processing from step S503 to step S506 is repeatedly executed (step S507). Finally, a message for returning the touch probe 65 to the original tool is displayed on the display unit 4 in step S508, and the processing ends.

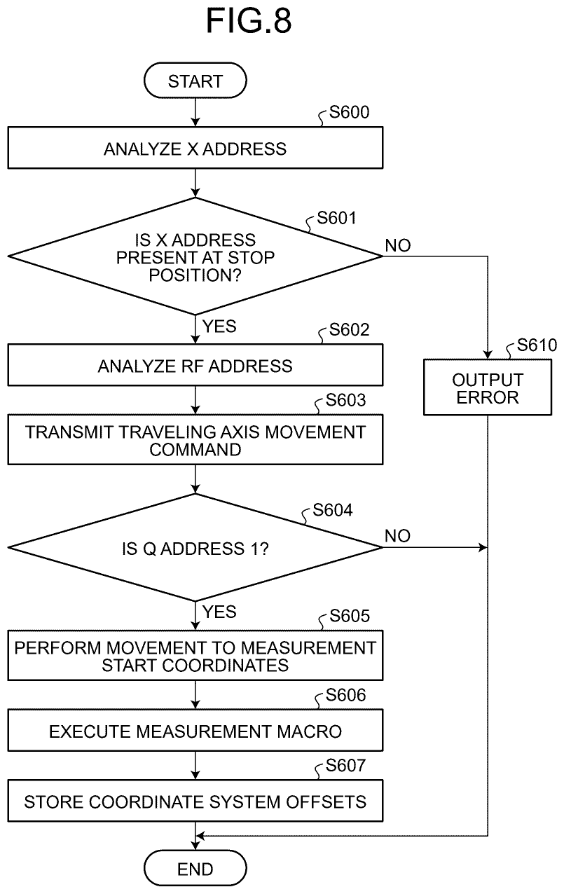

Next, processing of the coordinate system offset reflection processing unit 81 will be described. FIG. 8 is a flowchart illustrating an operation procedure of the coordinate system offset reflection processing unit 81 of the numerical control device 1 according to the first embodiment.

In step S600, the X address following the G-code in the machining program is analyzed, and the value of the address is stored in a temporary memory. In step S601, the determination is made whether the value of the address stored in the temporary memory is present as data at the stop position 349 of the coordinate system offset table 344. When the X address is not present in the stop position 349 (step S601: No), an error is output in step S610, and the processing ends. When the X address is present in the stop position (step S601: Yes), in step S602, the RF address is analyzed and the analyzed value is stored in the temporary memory. In step S603, a command for the traveling axis 62 to move to the stop position 349 stored in the temporary memory at the moving speed stored in the temporary memory, is transmitted to the robot controller 50.

Next, in step S604, the Q address is analyzed. When the Q address is 0 (step S604: No), the processing ends. When the Q address is 1 (step S604: Yes), in step S605, the robot 60 is moved to the measurement start coordinates 348 associated with the stop position 349, in step S606, the measurement macro 350 is executed, and in step S607, the re-measured measurement values are stored in the coordinate system offsets 346 of the coordinate system offset table 344.

As described above, according to the first embodiment, the numerical control device 1 stores, in the storage unit 34, the stop position 349, the measurement start coordinates 348, and the coordinate system offsets 346 for the machine tool 70 and the other machine tools 72 to 74 with the stop position 349, the measurement start coordinates 348, and the coordinate system offsets 346 being in association with the machine tool 70 and the other machine tools 72 to 74, measures the coordinate system offsets 346 of the machine tool 70 and the other machine tools 72 to 74 using the stop position 349 and the measurement start coordinates 348 stored in the storage unit 34 by the coordinate system offset measurement processing unit 80 and stores the measured coordinate system offsets 346 in the storage unit 34, and controls the robot 60 by reflecting the coordinate system offsets 346 stored in the storage unit 34 when the machining program is executed by the coordinate system offset reflection processing unit 81. This facilitates the operator to create the machining program for controlling the plurality of machine tools and the robot.

### Second Embodiment

A second embodiment adopts a configuration that a plurality of machine tools acquires a control right for a single self-propelled robot 161. In the second embodiment, the machine tool that has acquired the control right moves the self-propelled robot 161 to the measurement start position of the machine tool that has acquired the control right so as to measure and reflect the coordinate system offsets 346, thus accurately carrying in and carrying out the workpiece and machining the workpiece.

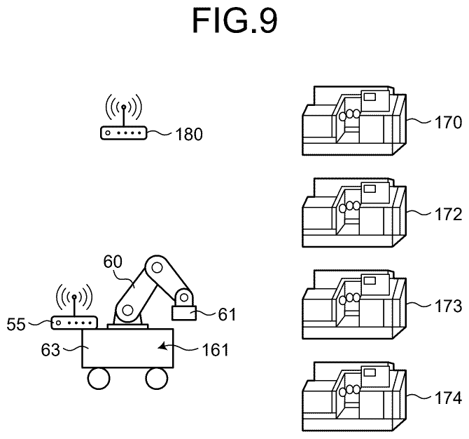

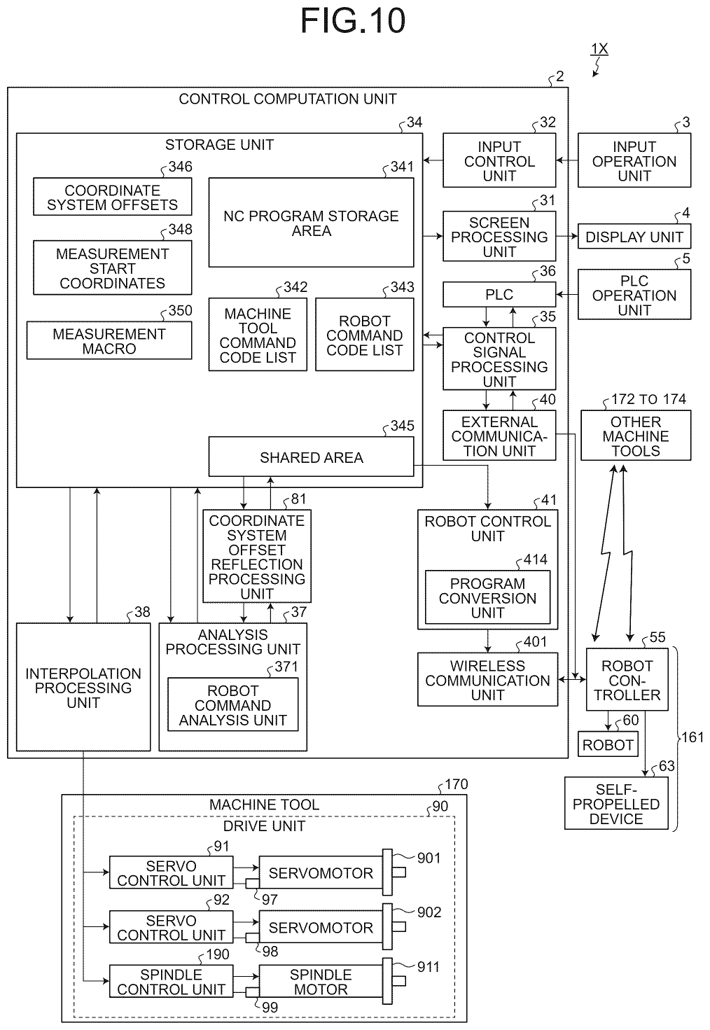

FIG. 9 is a diagram illustrating an exemplary configuration of a control system including a numerical control device according to the second embodiment. The control system illustrated in FIG. 9 includes a plurality of machine tools 170 and 172 to 174, the self-propelled robot 161, and a wireless LAN router 180. The machine tool 70 corresponds to a first machine tool, and the machine tool 172 corresponds to a second machine tool. A numerical control device 1X illustrated in FIG. 10 is disposed in the machine tool 170. The machine tool 170 is controlled by the numerical control device 1X. Each of the machine tools 172 to 174 is controlled by a corresponding one of a plurality of other numerical control devices (not illustrated) different from the numerical control device 1X.

The self-propelled robot 161 includes the robot 60, a self-propelled device 63, and a robot controller 55. The self-propelled robot 161 is an Automatic Guided Vehicle (AGV) in which the self-propelled device 63 allows the robot 60 and the robot controller 55 to autonomously travel. The self-propelled robot 161 includes, in the self-propelled device 63, a memory and a control device and travels around the plurality of machine tools 170 and 172 to 174 by autonomously traveling along the stored travel route. The robot controller 55 has a wireless LAN communication function and performs wireless communication with the machine tools 170 and 172 to 174 via the wireless LAN router 180.

The machine tools 170 and 172 to 174 can communicate with each other via the wireless LAN router 180. Additionally, the machine tools 170 and 172 to 174 and the robot controller 55 can communicate with each other via the wireless LAN router 180. The machine tools 170 and 172 to 174 transmit commands to the robot controller 55 via a wireless LAN to control the self-propelled robot 161, thereby carrying a workpiece in or out of each of the machine tools 170 and 172 to 174, machining using a cutting tool attached to the robot hand 61, or the like.

Regarding the control right for the self-propelled robot 161, for example, the following method is adopted. Among the machine tools 170 and 172 to 174, one of the machine tools 170 and 172 to 174 that has acquired, from the self-propelled device 63 of the self-propelled robot 161 via wireless LAN communication, approach information indicating that the self-propelled robot 161 has approached, and that is in a state of being able to use the self-propelled robot 161 has the control right for the self-propelled robot 161. As the approach information, a distance measuring sensor capable of determining a distance to a measurement target is used. For example, the self-propelled robot 161 and the machine tools 170 and 172 to 174 are installed with devices for short-range wireless communication (e.g., Bluetooth), and the machine tools 170 and 172 to 174 each determine the approach of the self-propelled robot 161 and acquire the control right.

The method for determining the control right for the self-propelled robot 161 is not limited to the above. For example, a controller capable of communicating via a wireless LAN may be provided separately from the self-propelled robot 161 and the machine tools 170 and 172 to 174, the controller may perform determination whether the self-propelled robot 161 approaches the machine tools 170 and 172 to 174 and may control activation of the self-propelled robot 161 and the machine tools 170 and 172 to 174 in accordance with a result of the determination.

FIG. 10 is a diagram illustrating an exemplary configuration of the numerical control device 1X according to the second embodiment. The numerical control device 1X of the second embodiment additionally includes a wireless communication unit 401 in addition to the numerical control device 1 of the first embodiment. Additionally, the numerical control device 1X of the second embodiment includes no coordinate system offset measurement processing unit 80 of the numerical control device 1 of the first embodiment and no coordinate system offset table 344, in which the stop positions 349, the measurement start coordinates 348, and the coordinate system offsets 346 for the other machine tools 72 to 74 are stored, of the numerical control device 1 of the first embodiment. Additionally, the numerical control device 1X of the second embodiment stores, in the storage unit 34, no stop position 349 for the machine tool 70 of its own. Other configurations are the same as those of the first embodiment, and redundant description will be omitted.

The wireless communication unit 401 is a processing unit for achieving wireless LAN communication, and processes communication between the robot control unit 41 and the robot controller 55. Additionally, the external communication unit 40 performs communication of an industrial network via the wireless communication unit 401.

Furthermore, in the second embodiment, the machine tools 170 and 172 to 174 each store, in the storage unit 34, the measurement start coordinates 348 and the coordinate system offsets 346 for its own machine tools 170 and 172 to 174. For example, as in the first embodiment, the measurement start coordinates 348 are stored based on a simulation at the time of designing the factory line or based on manual operation.

Next, a description will be given of a method of measuring the coordinate system offsets 346 by the machine tool that has acquired the control right for the self-propelled robot 161 and controlling the self-propelled robot 161 in consideration of the measured coordinate system offsets 346.

The numerical control device of the machine tool that the self-propelled robot 161 has approached acquires the approach information via the wireless LAN communication function of the robot controller 55 of the self-propelled robot 161 and the wireless communication unit 401. The numerical control device receives the approach information and stores the information in the shared area 345 of the storage unit 34.

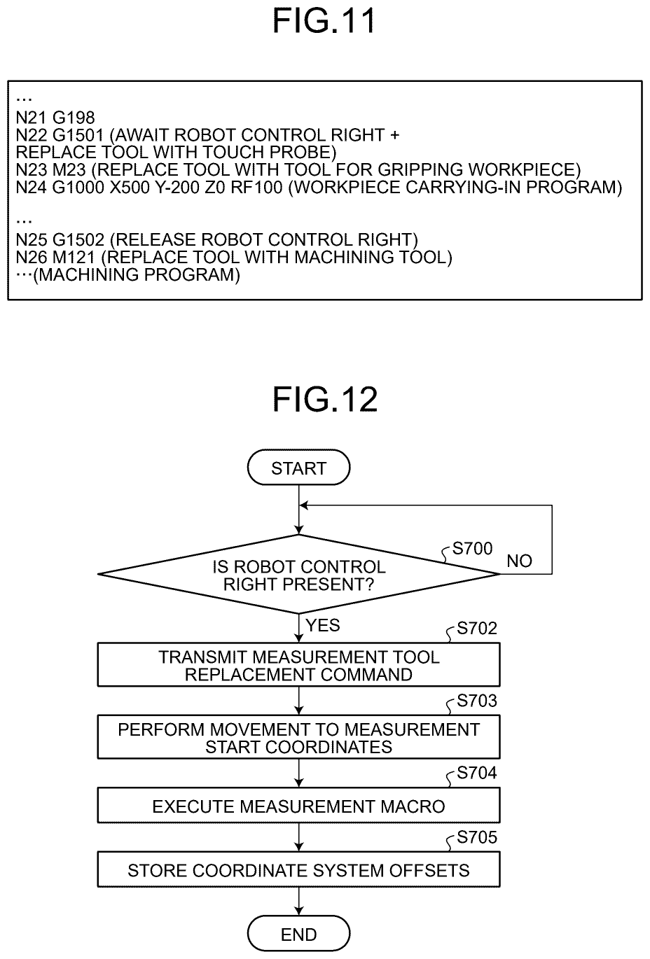

In the machining program executed by the machine tools 170 and 172 to 174, an instruction awaiting the robot control right is described by the operator, and the machining program including the instruction awaiting the robot control right is executed. FIG. 11 is a diagram illustrating an example of a machining program executed by the numerical control device 1X according to the second embodiment. The G1501 in the block N2 corresponds to the instruction awaiting the robot control right. When the instruction awaiting the robot control right is analyzed by the analysis processing unit 37, the machine tools each enter a robot control right awaiting state by the coordinate system offset reflection processing unit 81, which corresponds to the reflection processing unit.

When the approach information as the robot control right has been able to be acquired from the shared area 345, the coordinate system offset reflection processing unit 81 first transmits, to the robot controller 55, a command to replace the tool of the robot hand 61 with the touch probe 65. Consequently, the tool is replaced with the robot hand 61. Next, the coordinate system offset reflection processing unit 81 moves the self-propelled robot 161 to the measurement start coordinates 348 stored in the storage unit 34, then measures the coordinate system offsets 346 in accordance with the measurement macro 350, and stores the measured coordinate system offsets 346 in the storage unit 34.

When the measurement of the coordinate system offsets 346 is completed, the control right awaiting state is released. Next, a robot command described in a block N23 is executed, and carrying in and carrying out by the self-propelled robot 161 or machining by the robot hand 61 is performed. In the block N23, the M23 is executed, and the tool is replaced with a tool for gripping the workpiece. In the block N24, the G1000 is executed, and the carrying-in of the workpiece is performed. At the time of the workpiece carrying-in operation of the block N24, correction is performed based on the coordinate system offsets 346 stored in the storage unit 34, and the workpiece carrying-in operation is performed.

In a block N25, which is a block after the work program by the self-propelled robot 161, G1502 corresponding to a control right release auxiliary command is described. When the control right release auxiliary command is included, a command to release the control right is transmitted to the robot controller 55 via the control signal processing unit 35, the external communication unit 40, and the wireless communication unit 401. The robot controller 55, in response to receiving the command to release the control right, shifts the self-propelled robot 161 to the round operation and moves the self-propelled robot 161 to the next machine tool.

FIG. 12 is a flowchart illustrating an operation procedure of the coordinate system offset reflection processing unit 81 of the numerical control device 1X according to the second embodiment. The processing of the coordinate system offset reflection processing unit will be described with reference to FIG. 12.

The coordinate system offset reflection processing unit 81 determines, in step S700, whether the robot control right is present or absent. When the robot control right is absent (step S700: No), the processing transitions to the awaiting state, and thus, the coordinate system offset reflection processing unit 81 confirms again, in step S700, whether the robot control right is present or absent. When the robot control right is present (step S700: Yes), the coordinate system offset reflection processing unit 81 transmits, in step S702, a command to replace the tool with the touch probe 65, which is a measurement tool, to the robot controller. When the replacement with the measurement tool is completed, the coordinate system offset reflection processing unit 81 moves, in step S703, the self-propelled robot 161 to the measurement start coordinates 348, executes, in step S704, the measurement macro 350 to measure the coordinate system offsets 346, and stores, in step S705, the coordinate system offsets 346 in the storage unit 34.

As described above, in the second embodiment, the numerical control device of the machine tool that has acquired the robot control right controls the self-propelled robot 161, measures the coordinate system offsets, and then performs the carrying-in and carrying-out work reflecting the coordinate system offsets. Thus, even with the use of the self-propelled robot 161 in which the positioning accuracy with respect to the machine tool is not high, it is possible to achieve the highly accurate cooperation work between the machine tool 170 and the self-propelled robot 161.

Additionally, in the second embodiment, although the measurement start coordinates 348 are set in advance in each machine tool, the measurement start coordinates 348 are determined based on the arrangement of the self-propelled robot 161 and the table. Thus, when there is a plurality of machine tools of the same model, the values of the common measurement start coordinates 348 may be set. For example, in setting the measurement start coordinates 348 in the simulation, when the machine tools are determined to be of the same model, setting the same value as the measurement start coordinates 348 can eliminate time and effort for setting.

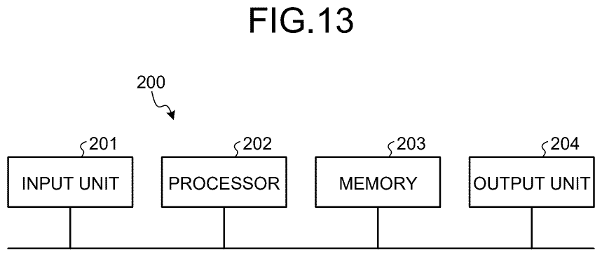

Next, hardware for implementing the control computation unit 2 according to the first and second embodiments will be described. The control computation unit 2 is implemented by processing circuitry. When the processing circuitry is implemented by software, the processing circuitry is, for example, a control circuit illustrated in FIG. 13. FIG. 13 is a block diagram illustrating an exemplary configuration of the control computation unit 2 of each of the numerical control devices 1 and 1X according to the first and second embodiments. The control circuit 200 includes an input unit 201, a processor 202, a memory 203, and an output unit 204. The input unit 201 is an interface circuit for receiving data input from the outside of the control circuit 200 and giving the data to the processor 202. The output unit 204 is an interface circuit for sending data from the processor 202 or the memory 203 to the outside of the control circuit 200.

The control computation unit 2 is implemented by software, firmware, or a combination of software and firmware. The software or firmware is described as a program and stored in the memory 203. In the processing circuitry, the processor 202 implements each function by reading and executing the program stored in the memory 203. That is, the processing circuitry includes the memory 203 for storing a program with which the processing of the control computation unit 2 is executed. It can also be said that these programs are programs for causing a computer to execute the procedure and method of the control computation unit 2.

The processor 202 is a Central Processing Unit (CPU) (also known as a central processing device, a processing device, a computing unit, a microprocessor, a microcomputer, processor, or a Digital Signal Processor (DSP)). The memory 203 corresponds to, for example, a nonvolatile or volatile semiconductor memory such as a Random Access Memory (RAM), a Read Only Memory (ROM), a flash memory, an Erasable Programmable Read Only Memory (EPROM), or an Electrically Erasable Programmable Read Only Memory (EEPROM, registered trademark), a magnetic disk, a flexible disk, an optical disk, a compact disk, a mini disk, a Digital Versatile Disc (DVD), or the like.

The configuration described in each of the above embodiments illustrates an example of the content of the present disclosure, may be combined with another known technique, and some of the configurations may be omitted or changed without departing from the gist of the present disclosure.

### REFERENCE SIGNS LIST

1, 1X numerical control device; 2 control computation unit; 3 input operation unit; 4 display unit; 5 PLC operation unit; 6 CNC unit; 31 screen processing unit; 32 input control unit; 34 storage unit; 35 control signal processing unit; 36 PLC; 37 analysis processing unit; 38 interpolation processing unit; 40 external communication unit; 41 robot control unit; 50, 55 robot controller; 51 input and output unit; 52 emergency stop button; 53 control panel; 60 robot; 61 robot hand; 62 traveling axis; 63 self-propelled device; 64 machining tool; 65 touch probe; 70, 170 machine tool; 71 table; 72 to 74, 172 to 174 other machine tools; 80 coordinate system offset measurement processing unit; 81 coordinate system offset reflection processing unit; 90 drive unit; 91, 92 servo control unit; 97, 98, 99 detector; 100 control system; 161 self-propelled robot; 180 wireless LAN router; 190 spindle control unit; 200 control circuit; 201 input unit; 202 processor; 203 memory; 204 output unit; 341 NC program storage area; 342 machine tool command code list; 343 robot command code list; 344 coordinate system offset table; 345 shared area; 346 coordinate system offsets; 348 measurement start coordinates; 349 stop position; 350 measurement macro; 371 robot command analysis unit; 401 wireless communication unit; 414 program conversion unit; 901, 902 servomotor; 911 spindle motor.

1. A numerical control device for controlling a plurality of machine tools and a robot to perform work on the plurality of machine tools, the numerical control device comprising:
a measurement processing unit to measure a coordinate system offset of each of the machine tools using a stop position of the robot at each machine tool in performing the work and a measurement start position that is a position to start a measurement operation of the coordinate system offset indicating a relationship between a coordinate system of each machine tool and a coordinate system of the robot;
an associating unit to associate, together with the stop position and the measurement start position, the coordinate system offset measured by the measurement processing unit with each machine tool; and
a reflection processing unit to control, in executing a machining program, the robot by reflecting the coordinate system offset associated.

2. The numerical control device according to claim 1, wherein
the associating unit includes a coordinate system offset table in which the stop position, the measurement start position, and the coordinate system offset are associated with each machine tool with the stop position, the measurement start position, and the coordinate system offset being in association with each other.

3. The numerical control device according to claim 2, wherein
the measurement processing unit stores the coordinate system offset in the coordinate system offset table with the coordinate system offset being in association with the stop position, and
the reflection processing unit reads the coordinate system offset associated with the stop position in the machining program from the coordinate system offset table and controls the robot by reflecting the coordinate system offset read.

4. The numerical control device according to claim 1, wherein
the machining program includes an instruction indicating whether to measure the coordinate system offset, and
the measurement processing unit determines whether to re-measure the coordinate system offset of the machine tool in accordance with contents of the instruction.

5. A numerical control device for controlling a robot to travel around a plurality of machine tools including a first machine tool and a second machine tool and to perform work on the plurality of machine tools, and for controlling the first machine tool, the numerical control device comprising:
a reflection processing unit to determine, in executing a machining program for performing a machining operation by the first machine tool, whether a control right for the robot is present or absent, and when the control right for the robot is present, to measure a coordinate system offset of the first machine tool using a measurement start position that is a position for starting a measurement operation of the coordinate system offset indicating a relationship between a coordinate system of the first machine tool and a coordinate system of the robot, and to control the robot by reflecting the coordinate system offset measured.

6. The numerical control device according to claim 5, wherein
when the second machine tool is identical in model to the first machine tool, the measurement start position is identical in value to a measurement start position set for the second machine tool.

7. A numerical control method for controlling a plurality of machine tools and a robot to perform work on the plurality of machine tools, the numerical control method comprising:
a measurement step of measuring a coordinate system offset of each of the machine tools using a stop position of the robot at each machine tool in performing the work and a measurement start position that is a position to start a measurement operation of the coordinate system offset indicating a relationship between a coordinate system of each machine tool and a coordinate system of the robot;
an associating step of associating, together with the stop position and the measurement start position, the coordinate system offset measured in the measurement step with each machine tool; and
a reflection processing step of controlling, in executing a machining program, the robot by reflecting the coordinate system offset associated.

8. (canceled)

9. The numerical control device according to claim 2, wherein
the machining program includes an instruction indicating whether to measure the coordinate system offset, and
the measurement processing unit determines whether to re-measure the coordinate system offset of the machine tool in accordance with contents of the instruction.

10. The numerical control device according to claim 3, wherein
the machining program includes an instruction indicating whether to measure the coordinate system offset, and
the measurement processing unit determines whether to re-measure the coordinate system offset of the machine tool in accordance with contents of the instruction.
